(19) United States
(12) Patent Application Publication
(10) Pub. No.: US 2005/0207314 A1
(43) Pub. Date: Sep. 22, 2005

(54) Optical element, optical head, optical information device and method of controlling optical head

(75) Inventors: Hidenori Wada, Kyoto (JP); Yoshiaki Komma, Osaka (JP)

Correspondence Address: RATNERPRESTIA, P O BOX 980, VALLEY FORGE, PA, 19482-0980, US

(73) Assignee: Matsushita Electric Industrial Co., Ltd.

(21) Appl. No.: 11/081,961

(22) Filed: Mar. 16, 2005

(30) Foreign Application Priority Data
Mar. 16, 2004 (JP) 2004-074251

(51) Int. Cl. G11B 7/135

(52) U.S. Cl. 369/112.08

(57) ABSTRACT

The Abstract has been amended. A revised Abstract is attached. An optical head includes a laser light source of emitting laser, an objective lens which focuses the laser emitted from the laser light source on an optical recording medium and an optical element placed between the light source and the optical recording medium, of which the transmittance varies depending on a voltage applied. The voltage applied to the optical element is switched so that the optical element has a lower transmittance upon reproducing a signal on the optical recording medium than upon recording a signal on the optical recording medium, at times when recording a signal on the optical recording medium and when reproducing a signal on the optical recording medium.

### BACKGROUND OF THE INVENTION

1. Field of the Invention

The present invention relates to an optical element, an optical head, an optical information device and a method of controlling an optical head, which are used for optical information processing or optical communication.

2. Related Art of the Invention

Recently, digital versatile disks (DVDs) have been attracting attention as a high capacity optical recording medium because of their capability of recording digital information with a recording density of about 6 times that of compact discs (CDs). Along with intense expansion of volume of information, however, an optical recording medium realizing an even higher density has been desired. To achieve a density higher than that of DVDs (wavelength 660 nm, numerical aperture (NA) 0.6), shortening of the wavelength of the light source and increase of the NA of the objective lens are required. For example, when a blue laser having a wavelength of 405 nm and an objective lens having an NA of 0.85 are used, a recording density of 5 times that of a DVD can be achieved.

However, high density optical disk devices using such blue laser have extremely critical reproduction margins, and thus have a problem of quantum noise of the light source. In this regard, Japanese Patent Application Laid Open No. 2000-195086 proposes an optical head which can suppress the quantum noise of a semiconductor laser to a lower level and perform high-end reproduction with reduced noise, while suppressing the power of the spot formed on the recording layer of an optical disk so as to prevent the deterioration of the optical disk and deletion of data.

That is, the optical head proposed in Japanese Patent Application Laid-Open No. 2000-195086 can solve the following problem.

Accordingly, the problem is as follows: when the power of a light source is reduced upon reproduction, quantum noise becomes remarkably noticeable; in the case of a high density optical disk device, the spot size of light collected on the optical disk is also extremely small, and thus the irradiation power per unit area of the optical disk is extremely high if the power of the light source is not reduced upon reproduction; in such case, due to an extremely high irradiation power of light per unit area of the optical disk, there is a risk that signals recorded on the optical disk are deleted upon reproduction. The optical head proposed in Japanese Patent Application Laid Open No. 2000-195086 solves such problem, and enables accurate recording of signals on an optical disk and accurate reproduction of signals recorded on the optical disk.

An example of the above-described conventional optical head is now described referring to a figure.

FIG. 11 is a schematic view illustrating a structure of a conventional optical head. In the figure, reference numeral 51 denotes a light source, reference numeral 52 denotes an intensity filter, reference numeral 53 denotes a beam splitter, reference numeral 54 denotes a collimating lens, reference numeral 55 denotes a mirror, reference numeral 56 denotes an objective lens, reference numeral 57 denotes an optical disk, reference numeral 58 denotes a multi lens and reference numeral 59 denotes a photodiode.

The light source 51 is a GaN blue light emitting semiconductor laser which emits coherent light of recording and reproduction to the recording layer of the optical disk 57. The intensity filter 52 is a device on which an absorption film is formed, which is provided movably for putting in and out. The beam splitter 53 is an optical element of splitting light. The collimating lens 54 is a lens of converting diverging light emitted from the light source 51 to parallel light. The mirror 55 is an optical element of reflecting incident light and directing it in the direction of the optical disk 57. The objective lens 56 is a lens that focuses light on the recording layer of the optical disk 57. The multi lens 58 is a lens that focuses light on the photodiode 59. And the photodiode 59 receives light reflected on the recording layer of the optical disk and converts the light into an electric signal.

The operation of a conventional optical head with the aforementioned structure is now described. When operating, the intensity filter 52 is inserted into an optical path upon reproduction and taken out from the optical path upon recording. Since light emitted from the light source 51 is transmitted through the intensity filter 52 upon reproduction, the light quantity is attenuated. Upon recording, on the other hand, the light quantity is not attenuated because the intensity filter 52 is taken out from the optical path.

Subsequently, the light transmitted through the intensity filter 52 (light emitted from the light source in the case of recording) is reflected by the beam splitter 53 and converted to parallel light by the collimating lens 54. The light converted to parallel light is reflected on the mirror 55 and focused on the optical disk 57 through the objective lens 56.

In the next step, the light reflected on the optical disk 57 is transmitted through the objective lens 56 and reflected on the mirror 55, then transmitted through the collimating lens 54 and the beam splitter 53, and focused on the photodiode 59 through the multi lens 58.

According to an astigmatism method, the photodiode 59 outputs a focus error signal which indicates the focused state of the light on the optical disk 57, and also outputs a tracking error signal which indicates the irradiated position of light.

An unrepresented focus control means controls the position of the objective lens 56 in the optical axis direction based on the focus error signal, so that light is collected on the optical disk 57 always in a focused state. An unrepresented tracking control means controls the position of the objective lens 56 based on the tracking error signal, so that the light is focused on a desired track on the optical disk 57.

In addition, a light detector 59 reproduces the information recorded on the optical disk 57.

According to such structure, reproduction can be conducted with setting the power of the light source to a level where quantum noise is sufficiently reduced while suppressing the power of the spot formed on the recording layer of the optical disk to a level where deterioration of optical disk or deletion of data does not occur, whereas upon recording, original power of the light source can be utilized for recording as it is.

### SUMMARY OF THE INVENTION

However, optical heads with the aforementioned structure require some mechanisms for insertion and taking out of the intensity filter 52, and this results in an increased size of the optical head. Thus, downsizing of such optical head is unattainable.

In short, conventional optical heads have a problem that downsizing of optical head cannot be achieved.

The present invention has been made in view of such conventional problems and aims at providing an optical element, an optical head, an optical information device and a method of controlling an optical head, which can conduct reproduction with setting the power of the light source to a level where quantum noise is sufficiently reduced while suppressing the power of the spot formed on the recording layer of the optical disk to a level where deterioration of optical disk or deletion of data does not occur, in which, upon recording, original power of the light source can be utilized for recording as it is, and which are suitable for downsizing of optical heads.

The 1^{st} aspect of the present invention is an optical element comprising:

an electrochromic material layer of which a transmittance varies depending on a voltage applied;

an electrolyte placed on one surface of the electrochromic material layer;

a first transparent electrode placed on the other surface of the electrochromic material layer; and

a second transparent electrode placed on a surface of the electrolyte opposite from the side of the electrochromic material layer,

wherein at least any of the first transparent electrode and the second transparent electrode has a plurality of electrodes which can apply different voltages to the electrochromic material layer.

The 2^{nd} aspect of the present invention is the optical element according to the 1^{st} aspect of the present invention, wherein the plurality of electrodes include a first circular electrode and a second electrode placed so as to enclose the first electrode.

The 3^{rd} aspect of the present invention is the optical element according to the 2^{nd} aspect of the present invention, wherein the plurality of electrodes further include one or a plurality of concentrically-shaped electrodes between the first electrode and the second electrode.

The 4^{th} aspect of the present invention is the optical element according to the 1^{st} aspect of the present invention, wherein the plurality of electrodes include a first oval electrode and a second electrode placed so as to enclose the first electrode.

The 5^{th} aspect of the present invention is the optical element according to the 4^{th} aspect of the present invention, wherein the plurality of electrodes further include one or a plurality of concentrically-shaped oval electrodes between the first electrode and the second electrode.

The 6^{th} aspect of the present invention is the optical element according to the 1^{st} aspect of the present invention, wherein the electrolyte is a liquid electrolyte.

The 7^{th} aspect of the present invention is the optical element according to the 1^{st} aspect of the present invention, wherein the electrolyte is a solid electrolyte.

The 8^{th} aspect of the present invention is the optical element according to the 1^{st} aspect of the present invention, wherein a material which is colored by an oxidation reaction is used for the electrochromic material layer.

The 9^{th} aspect of the present invention is the optical element according to the 1^{st} aspect of the present invention, wherein a material which is colored by a reduction reaction is used for the electrochromic material layer.

The 10^{th} aspect of the present invention is an optical head comprising:

a laser light source of emitting laser;

an objective lens which focuses the laser emitted from the laser light source on an optical recording medium; and

an optical element placed between the light source and the optical recording medium, of which a transmittance varies depending on a voltage applied,

wherein the voltage applied to the optical element is switched so that the optical element has a lower transmittance upon reproducing a signal on the optical recording medium than upon recording a signal on the optical recording medium, at times when recording a signal on the optical recording medium and when reproducing a signal on the optical recording medium.

The 11^{th} aspect of the present invention is the optical head according to the 10^{th} aspect of the present invention, further comprising a collimating lens placed between the objective lens and the laser light source, which converts the laser emitted from the laser light source into parallel light,

wherein the optical element is placed on the side of the laser light source or the side of the objective lens relative to the collimating lens.

The 12^{th} aspect of the present invention is the optical head according to the 10^{th} aspect of the present invention, wherein the laser light source has a wavelength of 390 nm to 420 nm.

The ¹³^{th} aspect of the present invention is the optical head according to the 10^{th} aspect of the present invention, wherein the optical element of the 1^{st} aspect of the present invention is used for the optical element.

The 14^{th} aspect of the present invention is the optical head according to the 11^{th} aspect of the present invention, wherein the optical element is placed on the side of the objective lens relative to the collimating lens and wherein the optical element of the 2^{nd} or the 3^{rd} aspect of the present invention is used for the optical element.

The 15^{th} aspect of the present invention is the optical head according to the 14^{th} aspect of the present invention, wherein the first electrode and the second electrode apply a voltage to the electrochromic material layer so that a portion of the electrochromic material layer corresponding to the first electrode has a smaller transmittance than a portion of the electrochromic material layer corresponding to the second electrode.

The 16^{th} aspect of the present invention is the optical head according to the 11^{th} aspect of the present invention, wherein the optical element is placed on the side of the laser light source relative to the collimating lens and wherein the optical element of the 4^{th} or the 5^{th} aspect of the present invention is used for the optical element.

The 17^{th} aspect of the present invention is the optical head according to the 16^{th} aspect of the present invention, wherein the first electrode and the second electrode apply a voltage to the electrochromic material layer so that a portion of the electrochromic material layer corresponding to the first electrode has a smaller transmittance than a portion of the electrochromic material layer corresponding to the second electrode.

The 18^{th} aspect of the present invention is an optical information device of recording or reproducing a signal on an optical recording medium, comprising:

a rotary drive means of rotating an optical recording medium, and

an optical head of recording or reproducing a signal on the optical recording medium,

wherein the optical head of the 10^{th} aspect of the present invention is used for the optical head.

The 19^{th} aspect of the present invention is a method of controlling an optical head comprising a laser light source of emitting laser,

an objective lens which focuses the laser emitted from the laser light source on an optical recording medium and

an optical element placed between the light source and the optical recording medium, of which the transmittance varies depending on a voltage applied,

which method comprises the step of switching the voltage applied to the optical element so that the optical element has a lower transmittance upon reproducing a signal on the optical recording medium than upon recording a signal on the optical recording medium, at times when recording a signal on the optical recording medium and when reproducing a signal on the optical recording medium.

The present invention can provide an optical element, an optical head, an optical information device and a method of controlling an optical head, which can conduct reproduction with setting the power of the light source to a level where quantum noise is sufficiently reduced while suppressing the power of the spot formed on the recording layer of the optical disk to a level where deterioration of optical disk or deletion of data does not occur, in which, upon recording, original power of the light source can be utilized for recording as it is, and which are suitable for downsizing of optical heads.

### BRIEF DESCRIPTION OF THE DRAWINGS

FIG. 1 is a schematic view illustrating an example of the optical head of Embodiment 1 of the present invention;

FIG. 2 is a cross-sectional view illustrating an example of the optical element in Embodiments 1 and 2 of the present invention;

FIG. 3 is a view illustrating an example of a patterned ITO film used for the optical element in Embodiment 1 of the present invention;

FIG. 4 is a table showing voltages applied to the ITO film of the optical element in Embodiment 1 of the present invention;

FIG. 5(a) is a view illustrating spatial distribution of light from a light source before being transmitted through the optical element in Embodiment 1 of the present invention, in which a patterned ITO film is used.

FIG. 5(b) is a view illustrating spatial distribution of light from a light source after being transmitted through the optical element in Embodiment 1 of the present invention, in which a patterned ITO film is used;

FIG. 6 is a view illustrating another example of a patterned ITO film used for the optical element in Embodiment 1 of the present invention;

FIG. 7 is a schematic view illustrating an example of the optical head of Embodiment 2 of the present invention;

FIG. 8 is a view illustrating an example of a patterned ITO film used for the optical element in Embodiment 2 of the present invention;

FIG. 9 is a view illustrating another example of a patterned ITO film used for the optical element in Embodiment 2 of the present invention;

FIG. 10 is a schematic view illustrating an example the optical information device of Embodiment 3; and

FIG. 11 is a schematic view illustrating an example of a conventional optical head.

Description of Symbols

1 Light source

2 Collimating lens

3 Optical element of the present invention

4 Polarizing beam splitter

5 First collective lens

6 First photodetector

7 ¼ wave plate

8 Objective lens

9 Optical recording medium

10 Cylindrical lens

11 Second collective lens

12 Second photodetector

22 first ITO film

23 Ni(OH)₂ film

24 KCl solution

25 Second ITO film

27 Sealing layer

41 Optical head

42 Motor

43 Processing circuit

### PREFERRED EMBODIMENTS OF THE INVENTION

In the following, embodiments of the present invention are described referring to the figures.

(Embodiment 1)

Embodiment 1 illustrates an example of the optical head of the present invention.

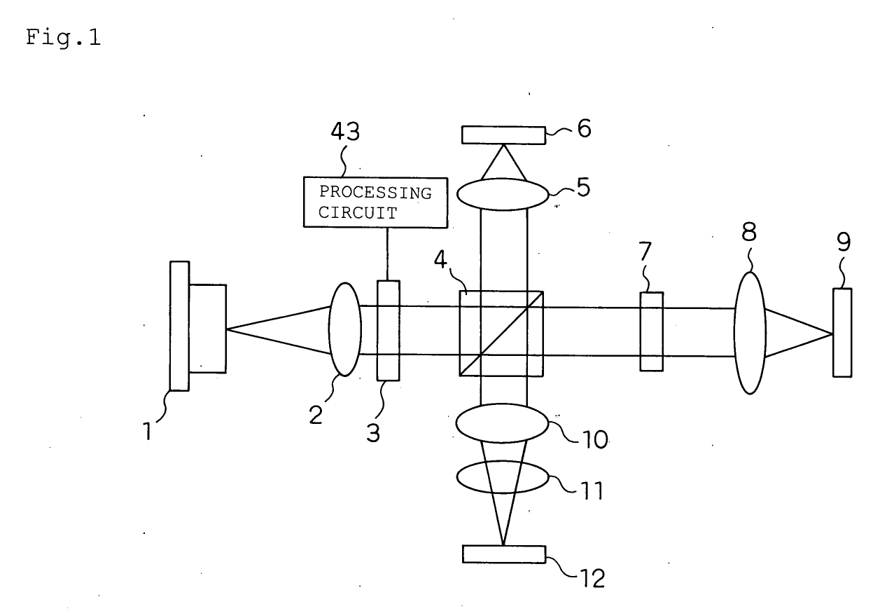

FIG. 1 is a view illustrating a structure of an optical head 17 of Embodiment 1. The optical head 17 of Embodiment 1 is equipped with an optical element of the present invention.

Referring in FIG. 1, reference numeral 1 denotes a light source, reference numeral 2 denotes a collimating lens, reference numeral 3 denotes an optical element of the present invention, reference numeral 4 denotes a polarizing beam splitter, reference numeral 5 denotes a first collective lens, reference numeral 6 denotes a first photodetector, reference numeral 7 denotes a ¼ wave plate, reference numeral 8 denotes an objective lens, reference numeral 9 denotes an optical recording medium, reference numeral 10 denotes a cylindrical lens, reference numeral 11 denotes a second collective lens and reference numeral 12 denotes a second photodetector. Here, the focused optical system is composed of the collimating lens 2 and the objective lens 8.

In addition, the processing circuit 43 is a circuit of controlling the transmittance of the optical element 3 so as to achieve an optimal transmittance of the optical element 3 upon reproduction and recording, which also controls other parts of the head. The details of the processing circuit 43 are described in embodiment below.

The optical element 3 described in Embodiment 1 is an example of the optical element 3 of the present invention.

The light source 1 is composed of, for example, a GaN semiconductor laser device (wavelength 390 nm to 420 nm) and emits coherent light of recording/reproduction to the recording layer of the optical recording medium 9. Since the wavelength employed for the light source 1 is a short wavelength of 390 nm to 420 nm, high density recording can be achieved.

The collimating lens 2 converts diverging light emitted from the light source 1 to parallel light.

The optical element 3, which is described in detail later, is an optical element of which the transmittance varies depending on external signals.

The polarizing beam splitter 4 is an optical element which has a transmittance of 90% and a reflectance of 10% relative to linearly polarized light emitted from the light source 1, and also has a reflectance of 100% relative to linearly polarized light in the direction perpendicular to the linearly polarized light emitted from light source 1.

The first collective lens 5 collects the light emitted from the light source 1 and reflected on the polarizing beam splitter 4 on the first photodetector 6.

The ¼ wave plate 7 is an optical element of converting incident linearly polarized light to circularly polarized light, or circularly polarized light to linearly polarized light.

The objective lens 8 collects light on the recording layer of the optical recording medium 9.

The cylindrical lens 10 imparts astigmatism to the light reflected on the optical recording medium 9 to detect focus error signals according to an astigmatic method.

The second collective lens 11 collects the light reflected on the optical recording medium 9 on the second photodetector 12. The first and second photodetectors 6 and 12 receive light and convert it into an electric signal.

The operation of this embodiment is now described.

Referring to FIG. 1, linearly polarized light emitted from the light source 1 enters the collimating lens 2 and is converted to parallel light from diverging light. The converted parallel light enters the optical element 3, and in the case of reproduction, the light quantity is attenuated while in the case of recording, the light quantity is not attenuated (details described later). The light transmitted through the optical element 3 enters the polarizing beam splitter 4 where part of the light is reflected while most is transmitted.

The reflected light enters the first photodetector 6 through the first collective lens 5, upon which the first photodetector 6 outputs an electric signal of controlling the light quantity of the light source 1. The light transmitted through the polarizing beam splitter 4 is converted to circularly polarized light from linearly polarized light by the ¼ wave plate 7, and the circularly polarized light is collected on the optical recording medium 9 through the objective lens 8.

Then, the light reflected on the optical recording medium 9 is transmitted through the objective lens 8 and converted to linearly polarized light perpendicular to the polarizing direction of the linearly polarized light emitted from the light source 1 from circularly polarized light by the ¼ wave plate 7, and reflected 100% at the polarizing beam splitter 4. Then astigmatism is given to the light by the cylindrical lens 10, and the light enters the second photodetector 12 through the second collective lens 11.

According to an astigmatism method, the second photodetector 12 outputs a focus error signal which indicates the focused state of light on the optical recording medium 9, and also outputs a tracking error signal which indicates the irradiated position of light. In this regard, in the case of an optical recording medium capable of reproduction only, for example, a phase contrast method is used, while in the case of an optical recording medium of recording, a push-pull method is used to receive tracking error signals.

An unrepresented focus control means controls the position of the objective lens 8 in the optical axis direction based on the focus error signal, so that light is collected on the optical recording medium 9 always in a focused state. In addition, an unrepresented tracking control means controls the position of the objective lens 8 based on the tracking error signal, so that the light is focused on a desired track on the optical recording medium 9. Further, the information recorded on the optical recording medium 9 is received from the second photodetector 12.

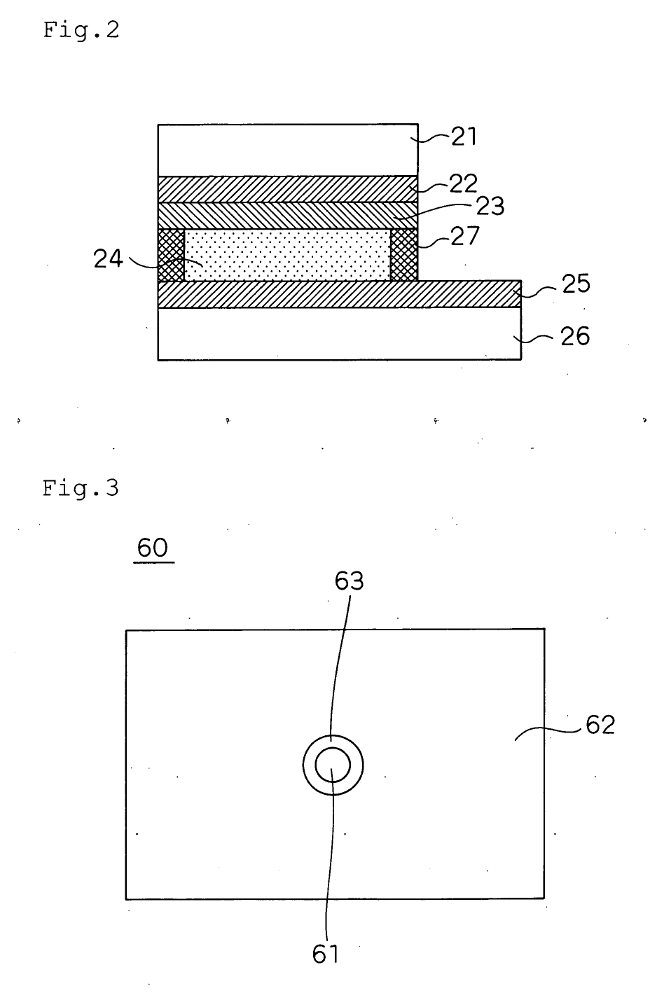

Herein, the details of the optical element 3 are described. FIG. 2 is a cross-sectional view of the optical element 3. In FIG. 2, reference numeral 21 denotes first glass, reference numeral 22 denotes a first ITO film, reference numeral 23 denotes a Ni(OH)₂ film, reference numeral 24 denotes a KCl solution, reference numeral 25 denotes a second ITO film, reference numeral 26 denotes second glass and reference numeral 27 denotes a sealing layer.

On one side of the Ni(OH)₂ film 23, the KCl solution 24 is placed being sealed by the sealing layer 27. On the other side of the Ni(OH)₂ film 23, a first ITO film is placed. In addition, a second ITO film 25 is placed on the surface of the KCl solution 24 opposite from the side of the Ni(OH)₂ film 23. The first glass 21 and the second glass 26 are placed on the first ITO film and the second ITO film 25, respectively.

The first ITO film 22 and the second ITO film 25 in this embodiment are each examples of the first and second transparent electrodes in the present invention; the Ni(OH)₂ film 23 in this embodiment is an example of the electrochromic material layer in the present invention; and the KCl solution in this embodiment is an example of the electrolyte in the present invention.

Next, operation of the optical element 3 is described.

Ni(OH)₂ has an electrochromic characteristic and so when electric energy is applied from outside, a reduction reaction is caused by electrons supplied from electrolyte, and the material changes from colorless to brown and absorbs blue light. On the other hand, when electric energy is not applied from outside, an oxidation reaction is caused between the material and the electrolyte, and thus the material changes from brown to colorless.

Accordingly, when a voltage (V1) is applied between the first ITO film 22 and the second ITO film 25, a reduction reaction is caused in the Ni(OH)₂ film 23, upon which the transmittance of the optical element 3 is decreased due to absorption of blue light. On the other hand, when the application of voltage between the first ITO film 22 and the second ITO film 25 is stopped, an oxidation reaction is caused in the Ni(OH)₂ film 23, whereby the transmittance of the optical element 3 reaches 100%. In short, the transmittance of the optical element 3 varies depending on the voltage applied from outside, and the light quantity transmitted through the optical element 3 varies.

By this, the optical element 3 can reduce the transmittance upon reproduction and increase the transmittance upon recording. Thus, although the optical head of Embodiment 1 does not contain a mechanism of insertion and taking out of an intensity filter as in the conventional optical head described in the Related Art section, the optical head of Embodiment 1 can reduce the transmittance upon reproduction and increase the transmittance upon recording by using the optical element 3. Accordingly, for the optical head of this embodiment, further downsizing is possible contrary to the conventional optical head described in the Related Art section.

In addition, because a KCl solution 24 which is liquid is used as an electrolyte layer, the optical element 3 can be colored faster than in the case of using solid electrolyte upon application of a voltage to the optical element 3.

The variation of transmittance according to an external voltage can also be accomplished by changing the polarization characteristic of incident light. For example, when an optical element 3 is formed by using liquid crystal, application of a voltage maintains a linear polarization direction of incident light, while application of a different voltage can create linearly polarized light in a direction different from the linear polarization direction of the incident light. And by using an optical element of which the transmittance varies depending on the polarizing direction, such as a polarizing beam splitter, the light transmittance can be changed. However, the polarizing direction of light emitted from the light source 1 is subject to rotation depending on the ambient temperature or the emission power, and thus variation of transmittance utilizing the polarization characteristic is unstable. On the other hand, the optical element 3 of the present invention is extremely stable because the transmittance of the film itself is changed regardless of the polarization characteristic.

In the case that the light source 1 is controlled so as to secure the polarizing direction of the light emitted from the light source 1, a device such as liquid crystal in which transmittance is varied by changing the polarization characteristic of incident light may be used as the optical element 3 for the optical head of Embodiment 1. In short, the optical element used for the optical head of the present invention may be a device of which the transmittance varies by control of voltages to be applied.

As described above, by using the optical element 3 of Embodiment 1 for an optical head, reproduction can be conducted with setting the power of the light source to a level where quantum noise is sufficiently reduced, while suppressing the power of the spot formed on the recording layer of the optical disk to a level where deterioration of optical disk or deletion of data does not occur by reducing the transmittance of the optical element 3. And upon recording, original power of the light source 1 can be utilized for recording as it is by setting the transmittance of the optical element 3 to 100%. Furthermore, since the transmittance is switched according to external electric signals, downsizing of the optical head is easy. Moreover, when an optical element 3 is formed by using a film of an electrochromic material, stability is extremely high because the transmittance of the film itself is changed.

In Embodiment 1, an unpatterned film having a uniform structure is used for the ITO film 22 and the ITO film 25, but the film is not limited to these. A patterned film having a non-uniform structure may also be used for either the ITO film 22 or the ITO film 25.

By using a patterned ITO film having a non-uniform structure for the optical element 3, an effect of further reducing the spot size of light focused on the recording medium 9 and an effect of increasing the recording density of signals on the optical recording medium 9 can also be achieved in addition to the effect of Embodiment 1 described above.

FIG. 3 illustrates an example of a patterned ITO film having a non-uniform structure, which is an ITO film 60.

The ITO film 60 has a first electrode 61, a second electrode 62 and an insulating layer 63. The first electrode 61 has a circular shape. The insulating layer 63 has a circular shape with the same center as the first electrode 61, and is placed so as to enclose the first electrode 61. The second electrode 62 is placed so as to enclose the insulating layer 63. In other words, the ITO film 60 has a structure in which the insulating layer 63 is placed around the first electrode 61 having a circular shape and the second electrode 62 is placed so as to enclose the insulating layer 63.

The reason why the first electrode 61 is circular is because the optical element 3 is put on the opposite side from the light source 1 relative to the collimating lens 2 as shown in FIG. 1. That is, the light beam from the light source 1 becomes circular after being transmitted through the collimating lens 2. The first electrode 61 is circular to accommodate the circular beam.

Since the insulating layer 63 is placed between the first electrode 61 and the second electrode 62, the first electrode 61 and the second electrode 62 are electrically insulated. Therefore, when different voltages are applied to the first electrode 61 and the second electrode 62, it means that the different voltages are applied to a portion corresponding to the first electrode 61 and a portion corresponding to the second electrode 62 of the Ni(OH)₂ film 23. In this way, the ITO film 60 has a plurality of electrodes which can apply different voltages to Ni(OH)₂ film 23.

Application of different voltages to the Ni(OH)₂ film 23 by the first electrode 61 and the second electrode 62 affords a spatially non-uniform distribution of transmittance when the Ni(OH)₂ film 23 is colored.

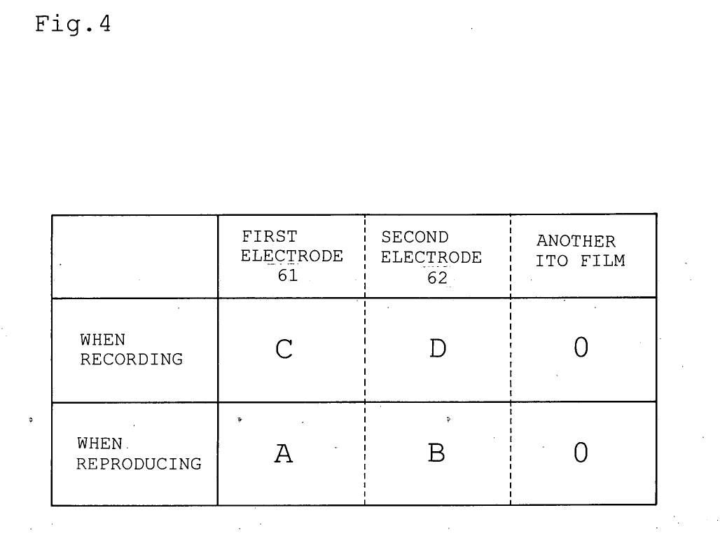

FIG. 4 shows voltages applied to the first electrode 61, the second electrode 62, and an ITO film without the first electrode 61 or the second electrode 62 of the ITO film 22 and the ITO film 25, when recording a signal on the optical recording medium 9 and when reproducing a signal recorded on the optical recording medium 9. In the following explanation, of the ITO film 22 and the ITO film 25, the ITO film without the first electrode 61 or the second electrode 62 is referred to as “another ITO film.”

The voltage values shown in FIG. 4 are based on the voltage value applied to another ITO film, and are indicated by the absolute value of a difference from the potential of another ITO film.

Upon recording, a voltage of C V is applied to the first electrode 61, a voltage of D V is applied to the second electrode 62 and a voltage of 0 V is applied to another ITO film as shown in FIG. 4. Upon reproduction, a voltage of A V is applied to the first electrode 61, a voltage of B V is applied to the second electrode 62 and a voltage of 0 V is applied to another ITO film as shown in FIG. 4.

In this case, voltages are applied to the first electrode 61 and the second electrode 62 so that A, B, C and D in FIG. 4 satisfy the following relationships.
C>D
A>B
C<A
D<B [Equation 1]

Specifically, upon recording, since Equation 1 establishes a relationship C>D, the applied voltage is greater at a portion of the Ni(OH)₂ film 23 corresponding to the first electrode 61 than at a portion of the Ni(OH)₂ film 23 corresponding to the second electrode 62. Therefore, the degree of coloring is higher, i.e., the transmittance is lower, at the portion of the Ni(OH)₂ film 23 corresponding to the first electrode 61 than at the portion of the Ni(OH)₂ film 23 corresponding to the second electrode 62.

Upon reproduction, since Equation 1 establishes A>B, the applied voltage is greater at a portion of the Ni(OH)₂ film 23 corresponding to the first electrode 61 than at a portion of the Ni(OH)₂ film 23 corresponding to the second electrode 62. Therefore, as in the case of recording, the degree of coloring is higher, i.e., the transmittance is lower, at the portion of the Ni(OH)₂ film 23 corresponding to the first electrode 61 than at the portion of the Ni(OH)₂ film 23 corresponding to the second electrode 62.

In this regard, however, since Equation 1 establishes a relationship C<A, the applied voltage at the portion of the Ni(OH)₂ film 23 corresponding to the first electrode 61 is greater upon reproduction than upon recording. Consequently, the degree of coloring at the portion of the Ni(OH)₂ film 23 corresponding to the first electrode 61 is higher, i.e., the transmittance is lower, upon reproduction than upon recording. In addition, since Equation 1 establishes a relationship D<B, the applied voltage at the portion of the Ni(OH)₂ film 23 corresponding to the second electrode 62 is greater upon reproduction than upon recording. Consequently, the degree of coloring at the portion of the Ni(OH)₂ film 23 corresponding to the second electrode 62 is higher, i.e., the transmittance is lower, upon reproduction than upon recording.

Since the first electrode 61, the second electrode 62 and another ITO film apply voltages to the Ni(OH)₂ film 23 upon recording and reproduction as described above, the optical element 3 has a smaller transmittance at the center than at the periphery both in the reproduction and the recording processes, and has a smaller transmittance at every portion upon reproduction than upon recording.

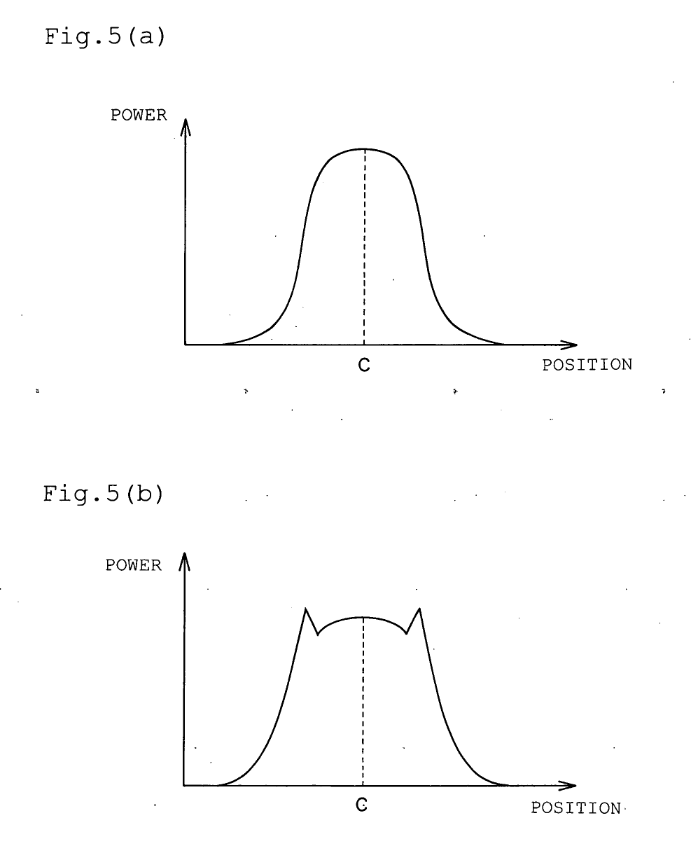

FIG. 5(a) shows distribution of the power of the light emitted from the light source 1 before being transmitted through the optical element 3, when a voltage is applied to the first electrode 61, the second electrode 62 and another ITO film as shown in FIG. 4 and Equation 1. FIG. 5(b) shows distribution of the power of the light emitted from the light source 1 after being transmitted through the optical element 3, when a voltage is applied to the first electrode 61, the second electrode 62 and another ITO film as shown in FIG. 4 and Equation 1. In FIG. 5(a) and FIG. 5(b) , the abscissa represents positions in the cross-section of the light beam from the light source, while the ordinate represents the power of light. FIG. 5(a) and FIG. 5(b) describe the data of the measurement of light in the recording process.

The light source 1 and the collimating lens 2 shown in FIG. 1 are adjusted in advance so that the cross-sectional center of the light beam from the light source 1 at the optical element 3 is the same as the center of the electrode 61, the cross-sectional diameter of the light beam from the light source 1 at the optical element 3 is larger than the diameter of the first electrode 61 and that the marginal portion of the cross-section of the light beam from the light source 1 at the optical element 3 also runs through the second electrode 62.

As is clear from FIG. 5(a), the power is maximized at a position c which is the cross-sectional center of the light beam from the light source 1 at the optical element 3, and the farther from the position c, the lower the power.

On the other hand, as is clear from FIG. 5(b), the power is lowered at the portion corresponding to the first electrode 61 including the position c which is the cross-sectional center of the light beam from the light source 1 at the optical element 3, as compared to FIG. 5(a). That is, the power of the central portion of the light beam transmitted through the optical element 3 is decreased as compared to the marginal portion.

As described above, by decreasing the power of the central portion of the light beam transmitted through the optical element 3, the spot size of the light from the light source 1 focused on the recording medium 9 can be made smaller. That is, by using the optical element 3 in which the ITO film 60 shown in FIG. 3 is used, the light from the light source 1 can be focused on the optical recording medium 9 in a narrower region.

Upon reproduction, the power of the light transmitted through the optical element 3 is attenuated in a greater amount than upon recording on the whole, and as in recording, the power of the light beam transmitted through the optical element 3 is attenuated in a greater amount particularly at the central portion than at the marginal portion.

Therefore, by decreasing the power of the central portion of the light beam transmitted through the optical element 3, the spot size of the light when focusing light from the light source 1 to the recording medium 9 can be made smaller also upon reproduction as in recording. That is, by using the optical element 3 in which the ITO film 60 shown in FIG. 3 is used, the light from the light source 1 can be focused on the optical recording medium 9 in a narrower region.

As illustrated above, by using the ITO film 60 shown in FIG. 3 either as the ITO film 22 or the ITO film 25 shown in FIG. 2, and by applying voltages as shown in FIG. 4 and Equation 1 upon recording and reproduction, an effect of focusing the light from the light source 1 on the recording medium 9 in a narrower region can be achieved in addition to the aforementioned effect of embodiment. As a result, the resolution of the optical head of Embodiment 1 can be improved and thus recording and reproduction of high density signals can be achieved by the optical recording medium 9.

In the case of using an ITO film 60 of FIG. 3 for the optical element 3, positions must be determined when setting the optical element 3 to the optical head of FIG. 1 so that the center of the light beam from the light source 1 corresponds to the center of the electrode 61 of the ITO film 60 when transmitted through the optical element 3. However, when the positions of the optical element 3 and other components are determined and steadily fixed when producing the optical head of FIG. 1, it is not necessary to adjust the position of the optical element 3 again upon recording or reproduction.

On the other hand, if an intensity filter 52 in which the transmittance of the center portion is lower than that of the marginal portion is used as a conventional intensity filter 52 for an optical head, the center of the intensity filter 52 and the center of the light beam from the light source 1 must be accurately aligned every time the intensity filter 52 is inserted into the path of light beam from the light source 1 upon recording and reproduction.

Thus, in addition to a mechanism for insertion and taking out of the intensity filter 52, a mechanism for the positioning of the intensity filter 52 and light beam from the light source 1 is required. This means that in order to accomplish the same function as in the optical element 3 using the ITO film 60 of FIG. 3 with a conventional optical head, a positioning mechanism is further required and thus downsizing of the conventional optical head becomes more difficult. As described above, when using the ITO film 60 of FIG. 3 for the optical element 3, the optical head of this embodiment is far more advantageous than the conventional head from the viewpoint of downsizing.

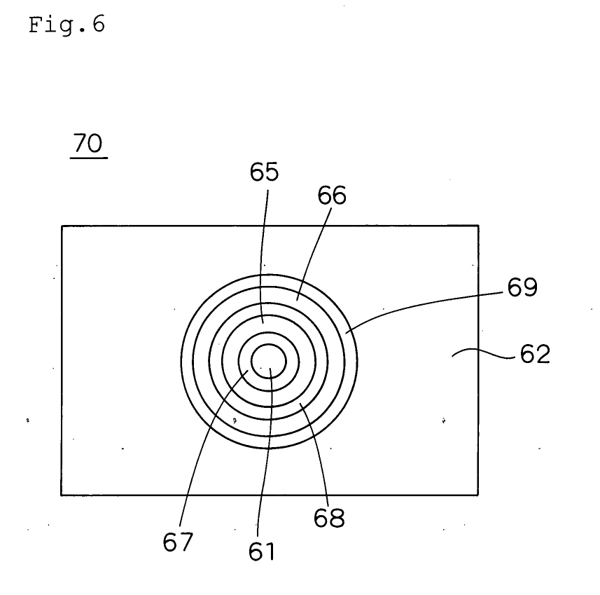

In the foregoing, the ITO film 60 shown in FIG. 3 which is a patterned ITO film having a non-uniform structure has been illustrated, but the ITO film is not limited to this. A similar effect as in the case of using the ITO film 60 shown in FIG. 3 can be obtained even by using an ITO film 70 shown in FIG. 6, which is a patterned ITO film having a non-uniform structure.

Referring to FIG. 6, the ITO film 70 has a first electrode 61, a second electrode 62, a third electrode 65 and a fourth electrode 66, a first insulating layer 67, a second insulating layer 68 and a third insulating layer 69.

The first electrode 61 has a circular shape. The insulating layer 67 has a circular shape with the same center as the first electrode 61, and is placed so as to enclose the first electrode 61. The third electrode 65 has a circular shape with the same center as the first electrode 61, and is placed so as to enclose the first insulating layer 67. The second insulating layer 68 has a circular shape with the same center as the first electrode 61, and is placed so as to enclose the third electrode 65. The fourth electrode 66 has a circular shape with the same center as the first electrode 61, and is placed so as to enclose the second insulating layer 68. The third insulating layer 69 has a circular shape with the same center as the first electrode 61, and placed so as to enclose the fourth electrode 66. The second electrode 62 is placed so as to enclose the third insulating layer 69.

In short, the ITO film 70 of FIG. 6 has one or a plurality of concentrically-shaped additional electrodes between the first electrode 61 and the second electrode 62. More specifically, with each electrode being electrically insulated by each insulating layer, the ITO film 70 of FIG. 6 has a plurality of electrodes which can apply different voltages to the Ni(OH)₂ film 23.

Thus, by using the ITO film 70 of FIG. 6 either as the ITO film 22 or the ITO film 25 of the optical element 3 and applying voltages to the Ni(OH)₂ film 23 from each electrode upon recording and reproduction as in the ITO film 60 of FIG. 4, the power of the central portion of the light beam transmitted through the optical element 3 can be reduced. As a result, an effect similar to that when using the ITO film 60 of FIG. 4 for the optical element 3 can be achieved.

The number of electrodes placed between the first electrode 61 and the second electrode 62 is not limited as long as those electrodes have the same center as the electrode 61.

(Embodiment 2)

Next, Embodiment 2 of the present invention is described referring to figures. Embodiment 2 is different from Embodiment 1 in the position of the optical element 3. Embodiment 2 is the same as Embodiment 1 except for this, and in Embodiment 2, absence of description means it is the same as in Embodiment 1, and thus such description is omitted. In Embodiment 2, the constituent members with the same reference numeral as in Embodiment 1 have the same function as that in Embodiment 1 unless otherwise noted.

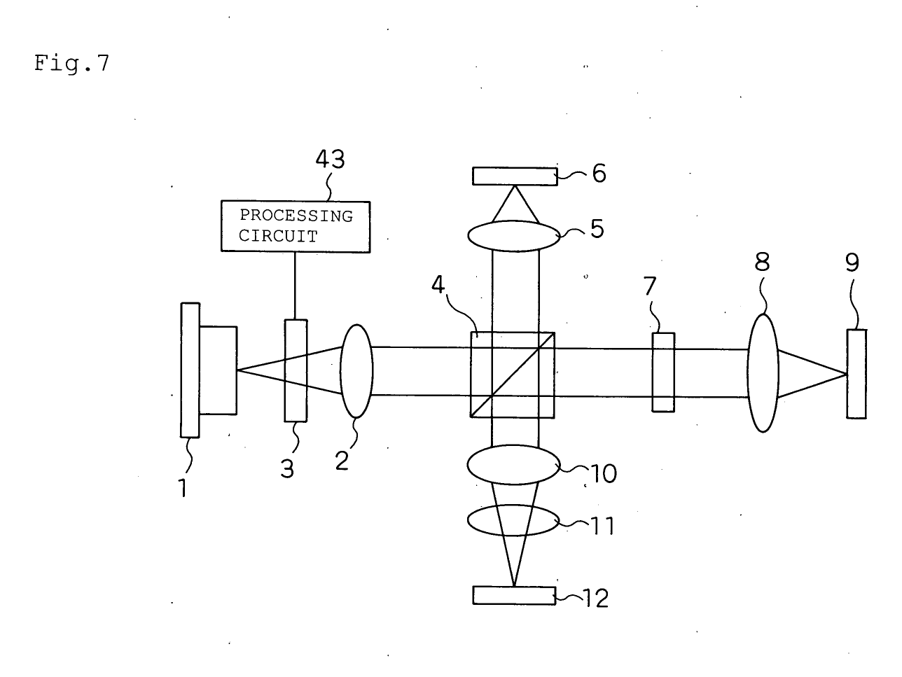

FIG. 7 is a view illustrating a structure of the optical head of Embodiment 2 of the present invention.

The optical head of Embodiment 2 shown in FIG. 7 is different from the optical head of Embodiment 1 shown in FIG. 1 in that the optical element 3 is placed between the collimating lens 2 and the light source 1. Except for that, the optical head of Embodiment 2 is the same as the optical head of Embodiment 1 shown in FIG. 1.

The operation of Embodiment 2 is now described.

Referring to FIG. 7, the linearly polarized light emitted from the light source 1 enters the optical element 3, and in the case of reproduction, the light quantity is attenuated while in the case of recording, the light quantity is not attenuated (described in Embodiment 1).

The light transmitted through the optical element 3 enters the collimating lens 2 and converted to parallel light from diverging light. The converted parallel light enters the polarizing beam splitter 4 where part of the light is reflected while most is transmitted.

The reflected light enters the first photodetector 6 through the first collective lens 5, upon which the first photodetector 6 outputs an electric signal of controlling the light quantity of the light source 1. The light transmitted through the polarizing beam splitter 4 is converted to circularly polarized light from linearly polarized light by the ¼ wave plate 7, and the circularly polarized light is collected on the optical recording medium 9 through the objective lens 8.

Then, the light reflected on the optical recording medium 9 is transmitted through the objective lens 8 and converted to linearly polarized light perpendicular to the polarizing direction of the linearly polarized light emitted from the light source 1 from circularly polarized light by the ¼ wave plate 7, and reflected 100% at the polarizing beam splitter 4. Then astigmatism is given to the light by the cylindrical lens 10, and the light enters the second photodetector 12 through the second collective lens 11.

According to an astigmatism method, the second photodetector 12 outputs a focus error signal which indicates the focused state of light on the optical recording medium 9, and also outputs a tracking error signal which indicates the irradiated position of light. In this regard, in the case of an optical recording medium capable of reproduction only, for example, a phase contrast method is used, while in the case of an optical recording medium of recording, a push-pull method is used to obtain tracking error signals.

An unrepresented focus control means controls the position of the objective lens 8 in the optical axis direction based on the focus error signal, so that light is collected on the optical recording medium 9 always in a focused state. In addition, an unrepresented tracking control means controls the position of the objective lens 8 based on the tracking error signal, so that the light is focused on a desired track on the optical recording medium 9. Further, the information recorded on the optical recording medium 9 is received from the second photodetector 12.

The difference with the optical head of Embodiment 1 is that the optical element 3 is placed between the collimating lens 2 and the light source 1, in other words, the optical element 3 is placed along the path of diverging light. It is herein described that downsizing of optical element 3 is more successful when placing the optical element 3 within diverging light than placing the optical element 3 within parallel light, defining the thickness of the optical element 3 as t and the average refractive index as n.

By placing the optical element 3 in diverging light as opposed to placing it in parallel light, the distance from the collimating lens 2 to the objective lens 8 can be shortened by t. In addition, the distance from the light source 1 to the collimating lens 2 increases (n−1)t when placing the optical element 3 in diverging light as opposed to placing the optical element 3 in parallel light. The total length of the optical head can be thus shortened by (2−n)t. For example, since the optical element 3 is mostly composed of glass, the refractive index n of the optical element 3 is assumed to be about 1.5, whereby the length of the optical head can be shortened by 0.5 t.

A transmittance variable optical element in which the polarization characteristic is changed as described in Embodiment 1 is now considered. An optical element in which the polarization characteristic can be changed has birefringent action by itself. Thus, when placed in diverging light, astigmatism is generated due to the birefringence. If the astigmatism does not fluctuate, it is sufficient to incorporate means of canceling the astigmatism when assembling an optical head. However, varying the transmittance means changing the birefringence of the optical element, and the generated astigmatism would be varied because the optical element is placed in diverging light, which results in a problem.

On the other hand, the optical element 3 of Embodiment 2 has no polarization characteristic, which means that the polarization characteristic is not varied and thus astigmatism is not caused even if the optical element 3 is placed in diverging light. Accordingly, the optical element 3 of Embodiment 2 is advantageous for placing in diverging light. In addition, because the optical element 3 of Embodiment 2 can also be used in a finite optical system, downsizing and low costs of optical head can be achieved.

By using the optical element 3 for an optical head, reproduction can be conducted with setting the power of the light source to a level where quantum noise is sufficiently reduced, while suppressing the power of the spot formed on the recording layer of the optical disk to a level where deterioration of optical disk or deletion of data does not occur by reducing the transmittance of the optical element 3. And upon recording, original power of the light source can be utilized for recording as it is by setting the transmittance of the optical element 3 to 100%. Furthermore, since the transmittance is switched according to external electric signals, downsizing of the optical head is easy. Moreover, when an optical element 3 is formed by using a film of an electrochromic material, the optical element 3 can be placed in diverging light because the transmittance of the film itself is changed and is suitable for further downsizing of the optical head. That is, further downsizing of the optical head can be achieved by placing an optical element 3 in diverging light in the optical head.

In Embodiment 2, an unpatterned film having a uniform structure is used for the ITO film 22 and the ITO film 25, but the film is not limited to these. A patterned film having a non-uniform structure may also be used for either the ITO film 22 or the ITO film 25.

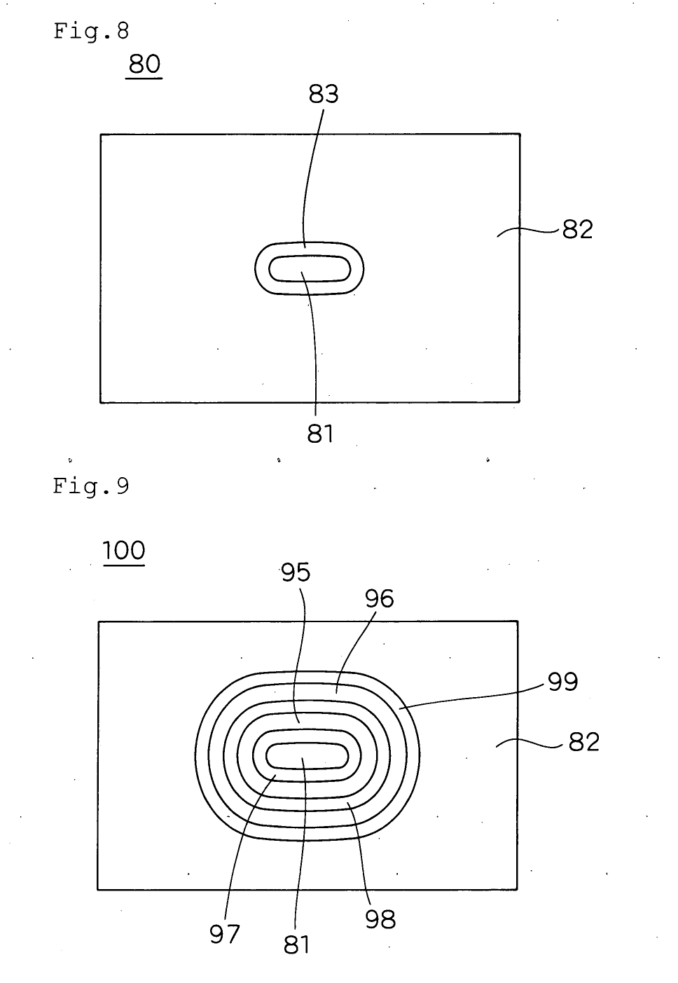

FIG. 8 illustrates a patterned ITO film 80 having a non-uniform structure. The ITO film 80 has a first oval electrode 81, an insulating layer 83 having the same center as the first electrode 81 and placed so as to enclose the first electrode 81, and a second electrode 83 placed so as to enclose the insulating layer 83.

The reason why the first electrode 81 and the rest in the ITO film 80 of FIG. 8 are oval is as follows.

That is, in Embodiment 2, the optical element 3 is placed on the light source side relative to the collimating lens 2 as described in FIG. 7; the light beam from the light source 1 is oval in the cross section perpendicular to the traveling direction before entering the collimating lens 2; thus, the light beam which enters the optical element 3 has an oval cross section perpendicular to the traveling direction and for this reason, the first electrode 81 and other components are made oval to conform with this beam shape. Other conditions are the same as in the ITO film 60 described referring to FIG. 3 and so the explanation is omitted.

In addition, an ITO film 100 illustrated in FIG. 9 may be used instead of the ITO film 80 of FIG. 8.

Referring to FIG. 9, the ITO film 100 has a first electrode 81, a second electrode 82, a third electrode 95 a fourth electrode 96, a first insulating layer 97, a second insulating layer 98 and a third insulating layer 99.

The first electrode 81 has an oval shape. The insulating layer 97 has an oval shape with the same center as the first electrode 81, and is placed so as to enclose the first electrode 81. The third electrode 95 has an oval shape with the same center as the first electrode 81, and is placed so as to enclose the first insulating layer 97. The second insulating layer 98 has a noval shape with the same center as the first electrode 81, and is placed so as to enclose the third electrode 95. The third insulating layer 99 has an oval shape with the same center as the first electrode 81, and is placed so as to enclose the fourth electrode 96. The fourth electrode 96 has an oval shape with the same center as the first electrode 81, and is placed so as to enclose the third insulating layer 99.

The second electrode 82 is placed so as to enclose the third insulating layer 99.

In short, the ITO film 100 of FIG. 9 has one or a plurality of additional concentrically-shaped oval electrodes between the first electrode 81 and the second electrode 82. More specifically, with each electrode being electrically insulated by each insulating layer, the ITO film 100 of FIG. 9 has a plurality of electrodes which can apply different voltages to the Ni(OH)₂ film 23.

The reason why the first electrode 81 and the rest in the case of ITO film 100 of FIG. 9 are oval is as described in the case of ITO film 80 of FIG. 8.

Other conditions are the same as in the ITO film 70 described referring to FIG. 6 and so the explanation is omitted.

In this embodiment, it is described that the optical element 3 is placed between the light source 1 and the collimating lens 2 of the optical head, in other words the optical element 3 is placed along the path of diverging light in the optical head, but the position is not limited to this. The optical element 3 may be placed between the optical recording medium 9 and the objective lens 8, i.e., along the path of convergent light in the optical head.

In this embodiment, it is described that the wavelength employed for the light source 1 is a short wavelength of 390 nm to 420 nm, but a wavelength outside the range of 390 nm to 420 nm may also be employed as the wavelength of the light source 1.

In Embodiments 1 and 2, the optical system is a polarized optical system, but there is no problem if an unpolarized optical system is used.

This embodiment describes use of Ni(OH)₂ film 23, but the material is not limited to this. Instead of the Ni(OH)₂ film 23 of this embodiment, other electrochromic materials with a characteristic of coloring upon application of a voltage may also be used.

Specifically, in this embodiment, a Ni(OH)₂ film 23 has been used as an electrochromic material, which is an electrochromic material colored by a reduction reaction; by using such material, an electrochromic material is colored by a reduction reaction, the transmittance of the electrochromic material varies depending on the voltage applied from outside, and this enables variation in the quantity of light transmitted through the optical element. However, the electrochromic material is not limited to materials to be colored by a reduction reaction, but there is no problem if a material to be colored by an oxidation reaction is used. By using an electrochromic material to be colored by an oxidation reaction, the transmittance of the electrochromic material layer varies depending on the voltage applied from outside, whereby the quantity of light transmitted through the optical element can be changed.

In addition, although a liquid electrolyte is used, there is no problem if solid electrolyte is used. When using solid electrolyte, the optical element 3 can be thinner than in the case of using liquid electrolyte.

(Embodiment 3)

Embodiment 3 describes an example of the optical information device of the present invention. The optical information device of Embodiment 3 conducts recording and reproduction of signals on the optical recording medium.

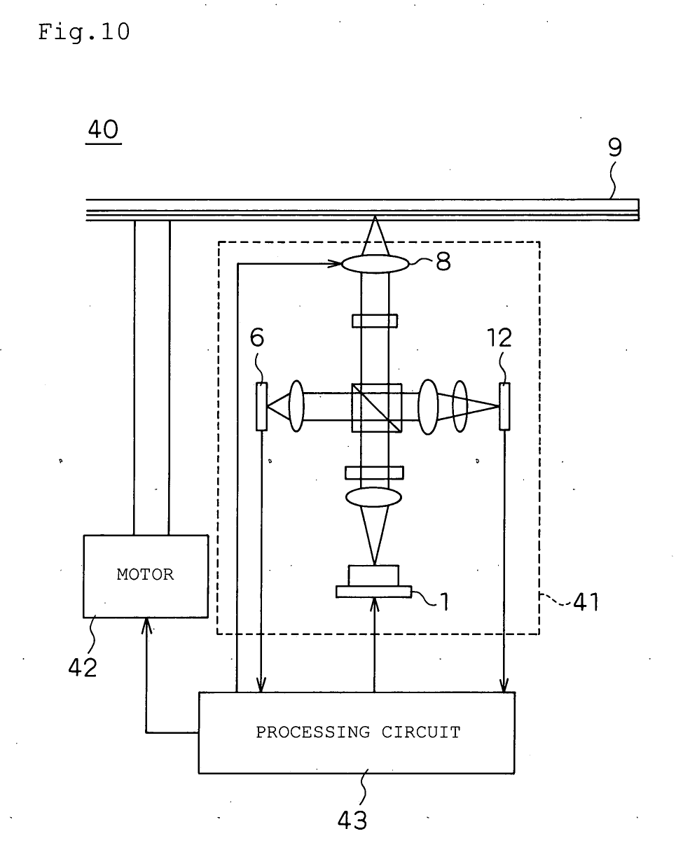

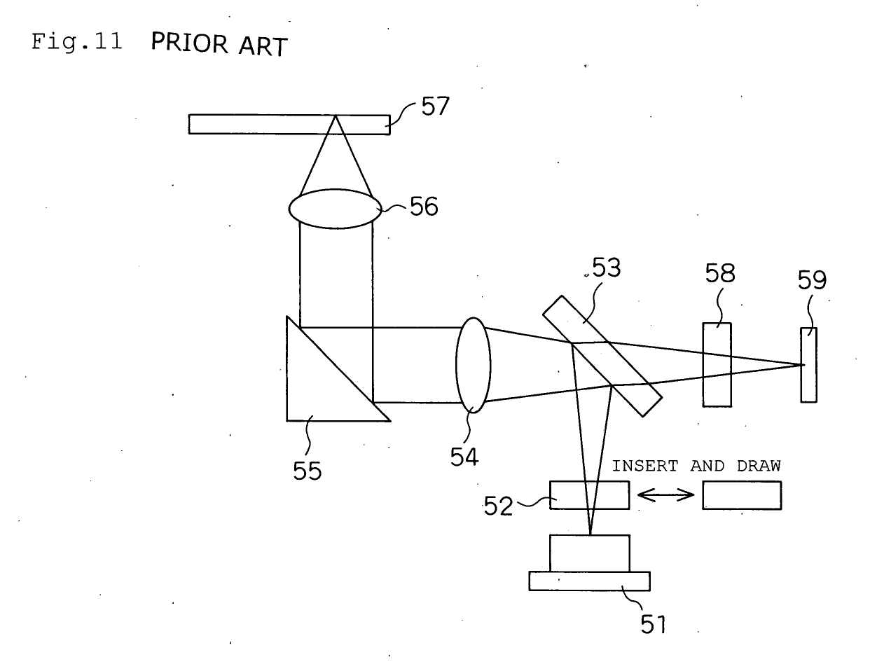

FIG. 10 schematically illustrates a structure of the optical information device 40 of Embodiment 3. The optical information device 40 has an optical head 41, a motor 42 which is rotary drive means and a processing circuit 43 which is control means. The optical head 41 is one described in Embodiment 1.

The optical head 41 is the same as that described in Embodiment 1 and so overlapping description is omitted.

Next, the operation of the optical information device 40 is described.

First, upon setting an optical recording medium 9 to the optical information device 40, the processing circuit 43 outputs a signal of rotating the motor 42 to rotate the motor 42. Then, the processing circuit 43 drives the light source 1 to emit light, and the light quantity of the light source 1 is controlled based on the output from a first photodetector 6. The processing circuit 43 also controls the transmittance of the optical element 3 so that the transmittance of the optical element 3 becomes optimal upon reproduction and recording.

The light emitted from the light source 1 is reflected on the optical recording medium 9 and enters the second photodetector 12. The second photodetector 12 outputs a focus error signal which indicates the focused state of light on the optical recording medium 9 and a tracking error signal which indicates the irradiated position of light to the processing circuit 43. Based on these signals, the processing circuit 43 outputs a signal of controlling the objective lens 8, by which the light emitted from the light source 1 is focused on a desired track on the optical recording medium 9. In addition, the processing circuit 43 reproduces the information recorded on the optical recording medium 9 based on the signals outputted from the second photodetector 12.

As described above, since the optical head of Embodiment 1 is used as an optical head, an optical information device 40 capable of conducting reproduction with setting the power of the light source 1 to a level where quantum noise is sufficiently reduced, while suppressing the power of the spot formed on the recording layer of the optical disk to a level where deterioration of optical disk or deletion of data does not occur by reducing the transmittance of the optical element 3 of the present invention, and which is capable of recording with original power of the light source 1 as it is by setting the transmittance of the optical element 3 to 100%, can be constructed.

In addition, because reproduction can be conducted with reduced quantum noise of a light source, an optical information device which affords stable control signals and reproduction signals can be constructed.

Furthermore, because the transmittance is switched based on electric signals from outside, downsizing of the optical head is easy and thus this is suitable for downsizing of an optical information device.

Explanation has been made using the optical head of Embodiment 1 as an optical head, but there is no problem if the optical head described in Embodiment 2 is used.

Referring to the objective lens, although a single lens is used, there is no problem if a combination lens having a high NA is used. Use of a lens having a high NA affords even higher density, making the stability of reproduction signals to the noise in the light source becomes severe, where the present invention is extremely useful.

Embodiments of the present invention have been described in detail with examples, but the present invention is not limited to the above-described embodiments. The present invention is applicable to any other embodiments supported by the technical idea of the present invention.

The above embodiments illustrate optical heads in a finite optical system, but an optical head in an infinite optical system without a collimating lens may also be used.

The above embodiments describe optical recording media on which information is recorded by light alone, but it is needless to say that the same effect can be obtained even with optical recording media on which information is recorded by light and magnetic wave, as long as the optical element of the present embodiment is used.

The above embodiments describe some instances in which the optical recording medium is an optical disk, but application to optical information devices which can achieve a similar function, such as a card optical recording medium, is also available.

The optical element, the optical head, the optical information device and the method of controlling an optical head of the present invention have an effect that reproduction can be conducted with setting the power of the light source to a level where quantum noise is sufficiently reduced while suppressing the power of the spot formed on the recording layer of the optical disk to a level where deterioration of optical disk or deletion of data does not occur, an effect that upon recording, original power of the light source can be utilized for recording as it is, and an effect that they are suitable for downsizing of optical heads, and therefore, they are useful for an optical element, an optical head, an optical information device and a method of controlling an optical head used for optical information processing or optical communication.

1. An optical element comprising:
an electrochromic material layer whose transmittance varies depending on a voltage applied;
an electrolyte placed on one surface of the electrochromic material layer;
a first transparent electrode placed on an other surface of the electrochromic material layer; and
a second transparent electrode placed on a surface of the electrolyte opposite from the side of the electrochromic material layer,
wherein at least any of the first transparent electrode and the second transparent electrode has a plurality of electrodes which can apply different voltages to the electrochromic material layer.

2. The optical element according to claim 1, wherein the plurality of electrodes include a first circular electrode and a second electrode placed so as to enclose the first circular electrode.

3. The optical element according to claim 2, wherein the plurality of electrodes further include one or a plurality of concentrically-shaped electrodes between the first circular electrode and the second electrode.

4. The optical element according to claim 1, wherein the plurality of electrodes include a first oval electrode and a second electrode placed so as to enclose the first oval electrode.

5. The optical element according to claim 4, wherein the plurality of electrodes further include one or a plurality of concentrically-shaped oval electrodes between the first oval electrode and the second electrode.

6. The optical element according to claim 1, wherein the electrolyte is a liquid electrolyte.

7. The optical element according to claim 1, wherein the electrolyte is a solid electrolyte.

8. The optical element according to claim 1, wherein a material which is colored by an oxidation reaction is used for the electrochromic material layer.

9. The optical element according to claim 1, wherein a material which is colored by a reduction reaction is used for the electrochromic material layer.

10. An optical head comprising:
a laser light source of emitting laser;
an objective lens which focuses the laser emitted from the laser light source on an optical recording medium; and
an optical element placed between the light source and the optical recording medium, of which a transmittance varies depending on a voltage applied,
wherein the voltage applied to the optical element is switched so that the optical element has a lower transmittance upon reproducing a signal on the optical recording medium than upon recording a signal on the optical recording medium, at times when recording a signal on the optical recording medium and when reproducing a signal on the optical recording medium.

11. The optical head according to claim 10, further comprising a collimating lens placed between the objective lens and the laser light source which converts the laser emitted from the laser light source into parallel light,
wherein the optical element is placed on the side of the laser light source or the side of the objective lens relative to the collimating lens.

12. The optical head according to claim 10, wherein the laser light source has a wavelength of 390 nm to 420 nm.

13. The optical head according to claim 10, wherein the optical element of claim 1 is used for the optical element.

14. The optical head according to claim 11, wherein the optical element is placed on the side of the objective lens relative to the collimating lens and wherein the optical element of claim 2 or 3 is used for the optical element.

15. The optical head according to claim 14, wherein the first electrode and the second electrode apply a voltage to the electrochromic material layer so that a portion of the electrochromic material layer corresponding to the first electrode has a smaller transmittance than a portion of the electrochromic material layer corresponding to the second electrode.

16. The optical head according to claim 11, wherein the optical element is placed on the side of the laser light source relative to the collimating lens and wherein the optical element of claim 4 or 5 is used for the optical element.

17. The optical head according to claim 16, wherein the first electrode and the second electrode apply a voltage to the electrochromic material layer so that a portion of the electrochromic material layer corresponding to the first electrode has a smaller transmittance than a portion of the electrochromic material layer corresponding to the second electrode.

18. An optical information device of recording or reproducing a signal on an optical recording medium, comprising:
a rotary drive means of rotating an optical recording medium, and
an optical head of recording or reproducing a signal on the optical recording medium,
wherein the optical head of claim 10 is used for the optical head.

19. A method of controlling an optical head comprising a laser light source of emitting laser,
an objective lens which focuses the laser emitted from the laser light source on an optical recording medium and
an optical element placed between the light source and the optical recording medium, of which the transmittance varies depending on a voltage applied,
which method comprises the step of switching the voltage applied to the optical element so that the optical element has a lower transmittance upon reproducing a signal on the optical recording medium than upon recording a signal on the optical recording medium, at times when recording a signal on the optical recording medium and when reproducing a signal on the optical recording medium.
